(19) United States
(12) Patent Application Publication
(10) Pub. No.: US 2022/0052468 A1
(43) Pub. Date: Feb. 17, 2022

(54) RECEPTACLE CONNECTOR

(71) Applicant: Molex, LLC, Lisle, IL (US)

(72) Inventors: Jin Hyup CHANG, Danwon-gu (KR); Sang Yong KO, Osan-si (KR); Kwang Sik KIM, Gunpo-si (KR)

(73) Assignee: Molex, LLC, Lisle, IL (US)

(21) Appl. No.: 17/413,587

(22) PCT Filed: Dec. 24, 2019
(86) PCT No.: PCT/US2019/068455

§ 371 Date: Jun. 14, 2021

(30) Foreign Application Priority Data
Dec. 27, 2018 (KR) 10-2018-0170312

(51) Int. Cl. H01R 12/70; H01R 12/72; H01R 13/24

(52) U.S. Cl. CPC H01R 12/7064; H01R 13/2407; H01R 12/727

(57) ABSTRACT

A receptacle connector is provided that is used for board-to-board connection. The connector includes: a housing including: first sidewall portions protruding along both side borders of a bottom portion that face each other; second sidewall portions protruding along the other side borders of the bottom portion that face each other to be connected with the first sidewall portions; a center protrusion portion protruding from a center of the bottom portion; and a connection recess portion formed between the first sidewall portions and the second sidewall portions, and the center protrusion portion; metal brackets soldered to a board and coupled to the second sidewall portions and protruding ends of the center protrusion portion; and terminals received in terminal holes formed on the housing, and the metal bracket includes a connection sensing member configured to provide a feeling of clicking of completion of connection by pressing a plug metal bracket.

### RELATED APPLICATIONS

This application claims priority to Korean Application No. 10-2018-0170312 filed on Dec. 27, 2018, which is incorporated herein by reference in its entirety.

### TECHNICAL FIELD

The present disclosure relates to a receptacle connector used for board-to-board connection.

### BACKGROUND ART

As a means for electrically connecting two or more components, the connectors normally used in electric and electronic industry fields are increasingly used with the development of electric and electronic industries.

In particular, when boards are connected with each other, one pair of connectors connected with the respective boards by soldering or the like are used, and these connectors are connected to each other, thereby electrically connecting the boards. A first connector of the one pair of connectors may be a receptacle connector, and a second connector may be a plug connector. The receptacle connector and the plug connector may be formed by arranging terminals on a mold forming portion of an insulating material, and the receptacle connector and the plug connector are connected to each other, forming an electric connector assembly.

As functions of electronic devices are diversified in recent years, the number of terminals arranged on mold forming portions of connectors increases, and connectors having terminals of 54 or more pins are developing, and accordingly, lengths of connectors increase.

Due to the increased lengths of the connectors, the receptacle connector and the plug connector may not be mated with each other simultaneously, and oblique mating is performed to connect on one side first and then connect along a direction of the other side. When the oblique mating is performed, all connections should be completed on both side ends in a longitudinal direction, and thus, there is a problem that an operator who mates the connectors may not easily detect completion of the connection. Furthermore, as connectors become longer and slimmer, it is more difficult to detect completion of connection.

In addition, following the trend toward miniaturization of electronic devices, connectors are miniaturized and mold forming portions for arranging terminals are also miniaturized and become slimmer. Accordingly, there is a problem that mold forming portions are vulnerable to an external force applied to connectors. For example, when a plug and a receptacle are connected to each other, a center protrusion of the receptacle which is formed of a mold forming portion repeatedly collides with a metal bracket of the plug formed with a metallic material, and is easily damaged.

Prior Art Documents: Patent Documents: Korean Patent Publication No. 10-2015-0027710 published on Mar. 12, 2015, Board-To-Board Connector

### SUMMARY

The present disclosure has been developed to solve the above-described problems, and an object of the present disclosure is to provide a receptacle connector which can enhance a feeling of clicking of completion of connection when connectors are mated with each other.

In addition, an object of the present disclosure is to provide a receptacle connector which reinforces stiffness of a mold forming portion with respect to a connector, which is miniaturized and becomes slimmer, and can prevent a damage of the mold forming portion caused by repeated connection.

To achieve the above-described objects, a receptacle connector of the present disclosure includes: a receptacle housing including: first sidewall portions protruding along both side borders of a bottom portion that face each other; second sidewall portions protruding along the other side borders of the bottom portion that face each other to be connected with the first sidewall portions; a center protrusion portion protruding from a center of the bottom portion; and a connection recess portion formed between the first sidewall portions and the second sidewall portions, and the center protrusion portion; receptacle metal brackets soldered to a board and coupled to the second sidewall portions and protruding ends of the center protrusion portion; and receptacle terminals received in receptacle terminal holes formed on the receptacle housing. The receptacle metal bracket includes: a first connection sensing member configured to provide a feeling of clicking of connection by elastically pressing the plug metal bracket; and a second connection sensing member configured to provide a feeling of clicking of connection by releasing pressure on the plug metal bracket.

Herein, the second sidewall portion may include a main body portion in a width direction, and extension portions extending from both ends of the main body portion in a longitudinal direction to be connected to the first sidewall portions. The receptacle metal bracket may include: a connection portion; a first reinforcing portion extending upward from an end of one side of the connection portion to be coupled to the main body portion; one pair of second reinforcing portions extending upward from ends of both sides of the connection portion to be coupled to the extension portions; and a third reinforcing portion extending upward from an end of the other side of the connection portion facing the first reinforcing portion to be coupled to the protruding end.

In addition, the first connection sensing member may include: a fixing piece formed by cutting a part of the second reinforcing portion and connected to the connection portion; and an elastic piece protruding inward from an end of the fixing piece to elastically press an outer surface of the plug metal bracket.

In addition, the third reinforcing portion may include side surface reinforcing portions coupled to both side surfaces of the protruding end.

In addition, the second connection sensing member may be a fixing projection or a projection recess which is formed on an outer surface of the side surface reinforcing portion to be engaged with a connection sensing member formed on a surface of the plug metal bracket.

In addition, the side surface reinforcing portions may be formed by being bent from both sides of an outer end surface of the third reinforcing portion toward the protruding end.

In addition, the third reinforcing portion may have a resin hole formed on the outer end surface thereof to allow a resin to flow therethrough.

In addition, the side surface reinforcing portions may be formed by being bent from both sides of an upper surface of the third reinforcing portion downward.

The present disclosure is provided with the connection sensing member to detect connection of the receptacle connector and the plug connector, thereby enhancing a feeling of clicking and thus preventing a connection error from occurring in a connector mating process.

In addition, the present disclosure can minimize a damage of a mold forming portion caused by repeated connection, by reinforcing stiffness of the mold forming portion by means of the metal bracket of a metallic material.

In addition, the present disclosure can minimize a defect in molding caused by an over molding process, by allowing a resin to smoothly flow into the metal bracket of the metallic material.

### BRIEF DESCRIPTION OF THE DRAWINGS

FIG. 1 is a perspective view showing a connector according to the present embodiment;

FIG. 2 is an exploded view showing the connector of FIG. 1;

FIG. 3 is a cross-sectional view of the connector of FIG. 2 in the coupled state, taken on line I-I;

FIG. 4 is a cross-sectional view of the connector of FIG. 2 in the coupled state, taken on line II-II;

FIG. 5 is a cross-sectional view of the connector of FIG. 2 in the coupled state, taken on line III-III;

FIG. 6 is a perspective view showing a receptacle connector according to the present embodiment;

FIG. 7 is an exploded view showing the receptacle connector of FIG. 6;

FIG. 8 is a perspective view showing an example of a receptacle metal bracket which is a main part of FIG. 6;

FIG. 9 is a perspective view showing another example of the receptacle metal bracket which is the main part of FIG. 6;

FIG. 10 is a perspective view showing a plug connector according to the present embodiment;

FIG. 11 is an exploded view showing the plug connector of FIG. 10; and

FIG. 12 is a perspective view showing a plug metal bracket which is a main part of FIG. 10.

### DETAILED DESCRIPTION OF THE PREFERRED EMBODIMENTS

The present disclosure and the technical objects achieved by embodiments of the present disclosure will be more apparent by preferred embodiments of the present disclosure which will be described below. Hereinafter, preferred embodiments of the present disclosure will be described in detail with reference to the accompanying drawings.

Differences in embodiments described hereinbelow should be understood as not being mutually exclusive. That is, specific shapes, structures, and characteristics described hereinbelow can be implemented in other embodiments in relation to one embodiment without departing from the technical concept and the scope of the present disclosure, and it should be understood that positions or arrangements of individual components within the respective embodiments disclosed herein can be changed. In the drawings, similar reference numerals indicate the same or similar functions in various aspects, and manufacturing raw materials, lengths, areas, and thicknesses, and shapes thereof may be expressed exaggeratedly for convenience. In the description of the present embodiment, expressions such as “front,” “rear,” “upper,” “lower,” “first,” “second,” or the like indicate relative positions, directions, or order with respect to different components, and the technical meanings thereof are not necessarily limited to dictionary meanings.

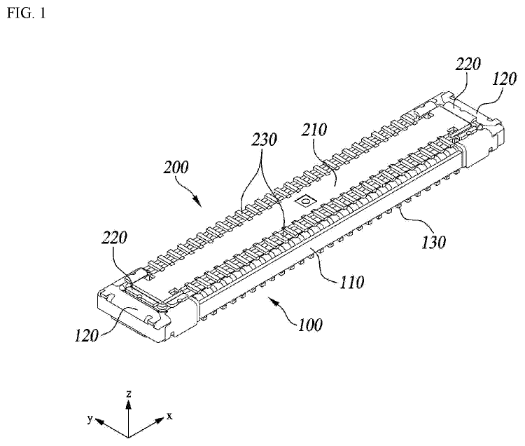

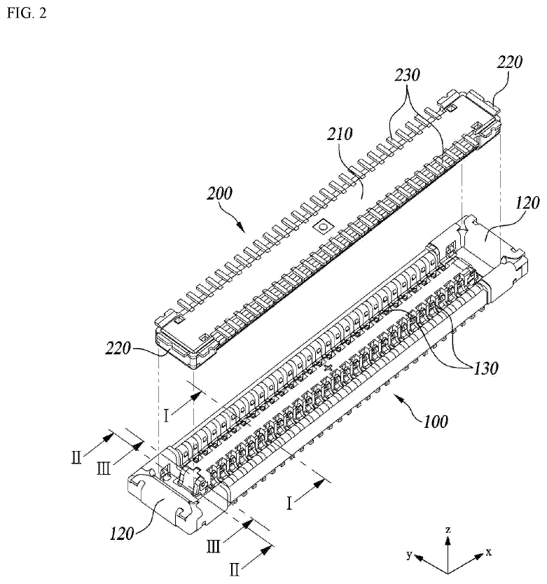

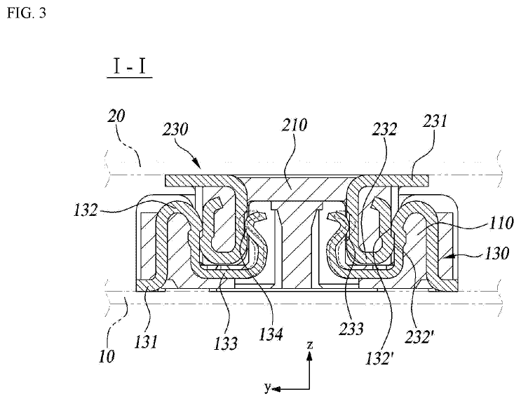

FIG. 1 is a perspective view showing a connector according to the present embodiment, FIG. 2 is an exploded view showing the connector of FIG. 1, and FIGS. 3 to 5 are cross-sectional views of the connector of FIG. 2 in the coupled state, taken on lines I-I, II-II, and III-III, respectively.

As shown in the drawings, the connector according to the present embodiment includes a receptacle connector 100 and a plug connector 200 connected to the receptacle connector 100.

The receptacle connector 100 is a first connector mounted on a first board 10, and includes a receptacle housing 110 of an insulating material, receptacle metal brackets 120 to reinforce stiffness of the receptacle housing 110, and a plurality of receptacle terminals 130 arranged in the receptacle housing 110.

The receptacle housing 110 may constitute a body of the receptacle connector 100, and may be formed by injecting molding with a resin of an insulating material. The receptacle metal brackets 120 may be soldered to the first board 10 at both ends of the receptacle housing 110, and may reinforce the stiffness of the receptacle housing 110 and may fix the receptacle housing 110 to the first board 10. The receptacle metal bracket 120 may be formed by pressing and bending a plate of a metallic material. The receptacle housing 110 and the receptacle metal brackets 120 may be integrally formed with each other by over molding.

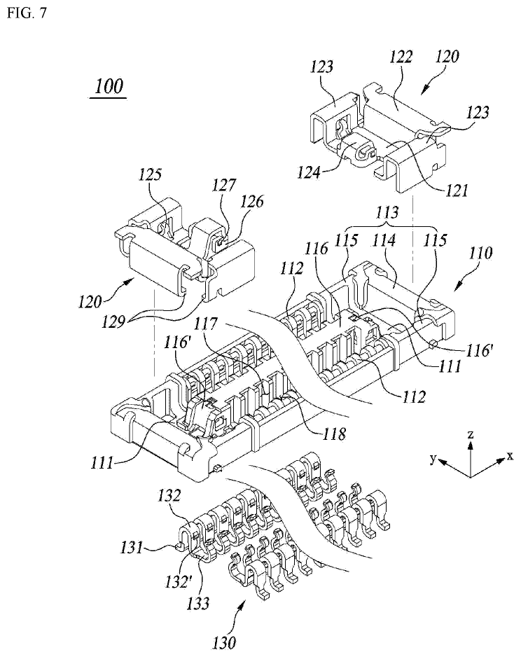

The receptacle terminal 130 has one end connected to the first board 10 and the other end coming into contact with a plug terminal 230 when being connected with the plug connector 200, and electrically connects the first board 10 and a second board 20 as shown in FIG. 3. The receptacle terminal 130 may be formed by pressing and bending a plate of a metallic material having excellent electrical conductivity, and may be integrally formed with a receptacle terminal hole 118 (see FIG. 7) by over molding.

In addition, the receptacle terminal 130 includes a first connection portion 131 connected to the first board 10, a first fixing portion 132 bending from the first connection portion 131 in an inverted U shape and received and fixed in the receptacle housing 110, and a first base portion 133 bending from an end of the first fixing portion 132 in a U shape. An inner space formed by the first base portion 133 receives the plug terminal 230. A contact protrusion 134 convexly protruding toward the inner space may be formed on an end of the first base portion 133 to come into contact with the plug terminal 230 received in the inner space.

The plug connector 200 is a second connector mounted on the second board 20, and includes a plug housing 210 of an insulating material, plug metal brackets 220 to reinforce stiffness of the plug housing 210, and a plurality of plug terminals 230 arranged in the plug housing 210.

The plug housing 210 may constitute a body of the plug connector 200, and may be formed by injecting molding with a resin of an insulating material. The plug metal brackets 220 may be soldered to the second board 20 at both ends of the plug housing 210, and may reinforce the stiffness of the plug housing 210 and may fix the plug housing 210 to the second board 20. The plug metal bracket 220 may be formed by pressing and bending a plate of a metallic material. In addition, the plug housing 210 and the plug metal brackets 220 may be integrally formed with each other by over molding.

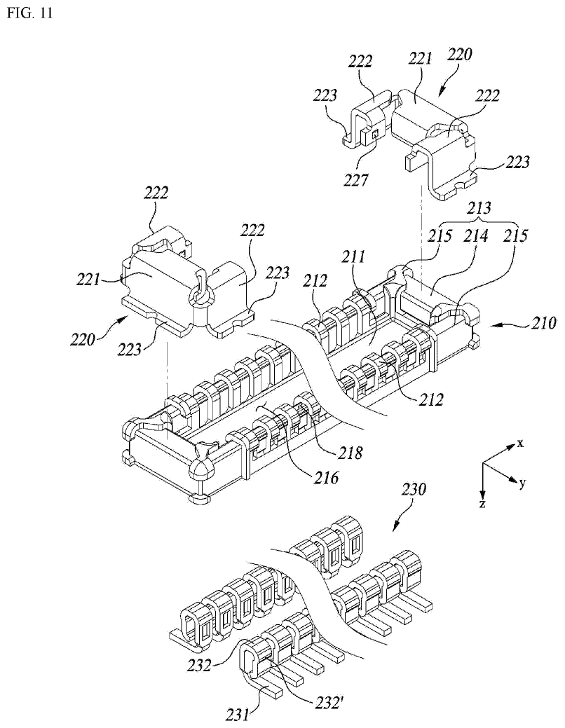

The plug terminal 230 has one end connected to the second board 20 and the other end coming into contact with the receptacle terminal 130 when being connected with the receptacle connector 100, and electrically connects the second board 20 and the first board 10. The plug terminal 230 may be formed by pressing and bending a plate of a metallic material having excellent electrical conductivity, and may be integrally formed with a plug terminal hole 218 (see FIG. 11) by over molding.

In addition, the plug terminal 230 includes a second connection portion 231 connected to the second board 20, and a second base portion 232 bending from the second connection portion 231 in a U shape. The second base portion 232 is inserted into the inner space of the first base portion 133 of the receptacle terminal 130, such that the plug terminal 230 is connected to the receptacle terminal 130. A contact recess 233 is concavely formed on a surface of an end of the second base portion 232, and the contact protrusion 134 having elasticity comes into contact with the contact recess 233, such that the receptacle terminal 130 and the plug terminal 230 are electrically connected with each other.

In addition, locking projections 132′, 232′ corresponding to each other in shape are formed on an end of the first fixing portion 132 (or a start portion of the first base portion), and an end of the second base portion 232, respectively, to be engaged with each other, and the receptacle terminal 130 and the plug terminal 230 contacting each other are not easily disconnected.

In addition, the connector of the present embodiment includes a connection sensing member to enhance a feeling of clicking of a connecting process and connection completion when the plug connector 200 is connected to the receptacle connector 100.

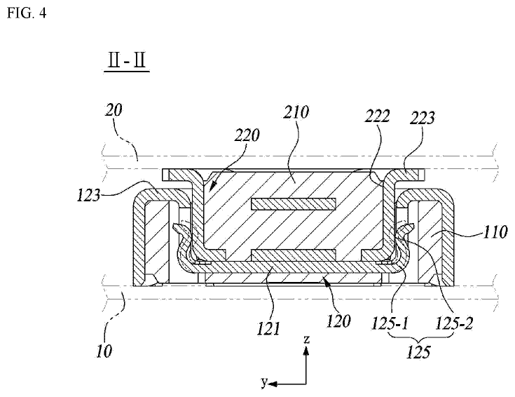

Referring to FIG. 4, an elastic protrusion 125 is formed on the receptacle metal bracket 120 as a first connection sensing member. The elastic protrusion 125 may be formed by cutting a part of the receptacle metal bracket 120, and may include a fixing piece 125-1 and an elastic piece 125-2 which protrudes inward from an end of the fixing piece 125-1 and has elasticity. When the receptacle connector 100 and the plug connector 200 are connected with each other, the elastic piece 125-2 elastically presses a side surface of the plug metal bracket 220. Accordingly, when the plug metal bracket 220 comes into contact with the elastic piece 125-2, a friction is exerted between the elastic piece 125-2 and the plug metal bracket 220 due to the elasticity of the elastic piece 125-2, and an operator may detect connection between the receptacle connector 100 and the plug connector 200 based on a feeling of clicking caused by the friction.

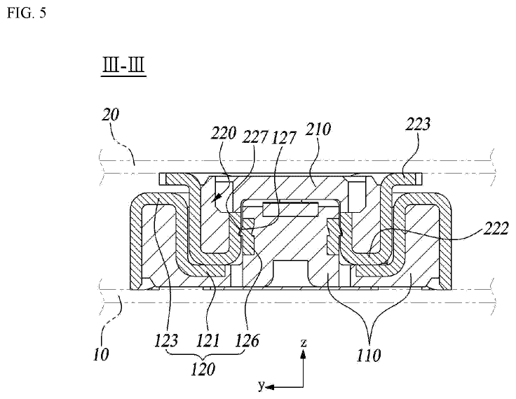

Referring to FIG. 5, a fixing projection 127 is formed on the receptacle metal bracket 120 as a second connection sensing member, and a projection recess 227 is formed on the plug metal bracket 220 to receive the fixing projection 127. When the receptacle connector 100 and the plug connector 200 are connected with each other, the fixing projection 127 presses a side surface of the plug metal bracket 220, and is seated and received in the projection recess 227 when connection is completed. Accordingly, when the fixing projection 127 comes into contact with a surface of the plug metal bracket 220, a strong friction is exerted, and, when the fixing projection 127 is seated in the projection recess 227, the friction disappears. Therefore, the operator can easily detect that connection between the receptacle connector 100 and the plug connector 200 is completed, based on a feeling of clicking caused by removal of the friction.

Accordingly, the connector of the present embodiment can prevent a connection error from occurring in a connector coupling process by providing a feeling of clicking to the operator through the first and second connection sensing members.

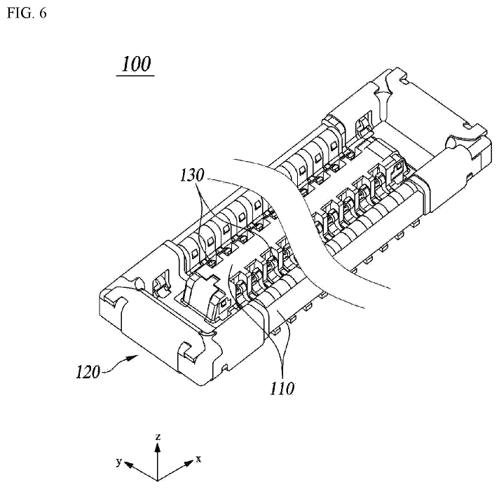

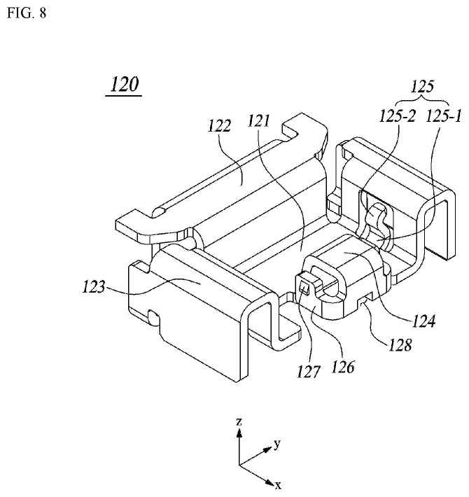

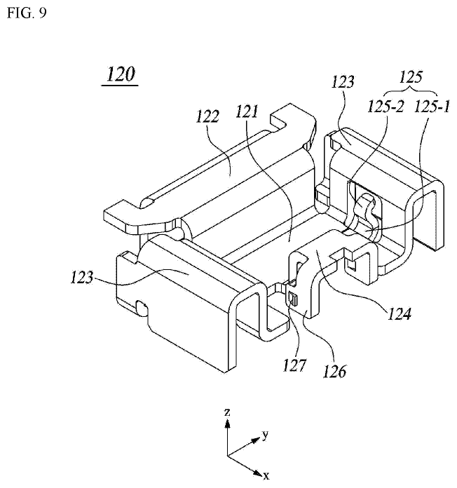

FIG. 6 is a perspective view showing the receptacle connector of the present embodiment, FIG. 7 is an exploded view showing the receptacle connector of FIG. 6, FIG. 8 is a perspective view illustrating an example of the receptacle metal bracket which is a main part of FIG. 6, and FIG. 9 is a perspective view of another example of the receptacle metal bracket which is the main part of FIG. 6.

As shown in FIGS. 6 and 7, in the receptacle connector 100 of the present embodiment, the receptacle housing 110 forms a rectangular parallelepiped shape having a predetermined width and a predetermined length, and includes a first bottom portion 111, one pair of first sidewall portions 112 protruding along both side borders of the first bottom portion 111 in a longitudinal direction, one pair of second sidewall portions 113 protruding along both side borders of the first bottom portion 111 in a width direction and connecting both ends of the first sidewall portion 112, a center protrusion portion 116 spaced part from the one pair of first sidewall portions 112 and the one pair of second sidewall portions 113, and protruding from a center of the first bottom portion 111 along the longitudinal direction, and a first connection recess portion 117 concavely formed between the center protrusion portion 116, and the one pair of first sidewall portions 112 and the one pair of second sidewall portions 113. The first bottom portion 111, the first sidewall portions 112, the second sidewall portions 113, and the center protrusion portion 116 are integrally connected with one another by injecting molding.

The first sidewall portions 112 are walls having a predetermined thickness, and face each other and are symmetric to each other on both sides of the first bottom portion 111 in the longitudinal direction.

The second sidewall portions 113 are walls having a predetermined thickness, and face each other and are symmetric to each other on both sides of the first bottom portion 111 in the width direction. In addition, the second sidewall portion 113 includes a first main body portion 114 forming a wall in the width direction, and one pair of first extension portions 115 extending inward from both ends of the first main body portion 114 in the longitudinal direction to be connected to the first sidewall portions 112.

The center protrusion portion 116 is a wall having a predetermined thickness and protrudes along the longitudinal direction, and has protruding ends 116′ formed on both sides thereof in the longitudinal direction.

The first connection recess portion 117 receives the plug housing 210 of the plug connector 200 to couple the receptacle connector 100 and the plug connector 200 to each other, and is formed in a track or rectangular shape between the center protrusion portion 116, and the first sidewall portions 112 and the second sidewall portions 113.

In addition, the receptacle terminal holes 118 concavely recessed or penetrating through the center protrusion portion 116, the first bottom portion 111 and the one pair of first sidewall portions 112 are formed. The plurality of receptacle terminal holes 118 may be formed at predetermined intervals along the longitudinal direction, and each of the receptacle terminal holes 118 receives the receptacle terminal 130.

The receptacle metal brackets 120 may be coupled to both ends of the receptacle housing 110, that is, the second sidewall portions 113 and the protruding ends 116′ of the center protrusion portion 116, thereby reinforcing stiffness of the receptacle housing 110 and fixing the receptacle housing 110 to the first board 10.

Referring to FIG. 8, the receptacle metal bracket 120 includes a first connection portion 121, a first reinforcing portion 122 extending upward from an external end of the first connection portion 121 to be coupled to the first main body portion 114 of the second sidewall portion 113, one pair of second reinforcing portions 123 extending upward from both ends of the first connection portion 121 to be coupled to the first extension portions 115 of the second sidewall portion 113, and a third reinforcing portion 124 extending upward from an inside end of the first connection portion 121 to be coupled to the protruding end 116′ of the center protrusion portion 116. A first soldering portion 129 is formed on end of each of the first reinforcing portion 122 and the second reinforcing portion 123.

The first to third reinforcing portions 122, 123, 124 of the receptacle metal bracket 120 surround the first main body portion 114 and the first extension portions 115 of the second sidewall portion 113, and the protruding end 116′ of the center protrusion portion 116, respectively, and are coupled thereto, thereby reinforcing stiffness thereof, and the first soldering portions 129 are soldered to the first board 10, thereby fixing the receptacle housing 110.

The first to third reinforcing portions 124 may be bent and extend from an end of the first connection portion 121 in an inverted U shape, and the first reinforcing portion 122 and the second reinforcing portions 123 may be bent from ends of the first connection portion 121 from inside to outside or from outside to inside.

In addition, the second reinforcing portion 123 may include an elastic protrusion 125 to notify connection of the plug connector 200. The elastic protrusion 125 may be formed by cutting a part contacting an inner surface of the first extension portion 115, and includes a fixing piece 125-1 formed on one side connected to the first connection portion 121, and an elastic piece 125-2 formed on the other side end and convexly protruding inwardly. The fixing piece 125-1 may be connected and fixed to the first connection portion 121, and the elastic piece 125-2 may be supported on the fixing piece 125-1, and is spaced apart from the second reinforcing portion 123 and has elasticity. When the plug connector 200 is connected to the receptacle connector 100, the elastic piece 125-2 of the elastic protrusion 125 elastically presses an outer surface of the plug metal bracket 220 (see FIG. 4).

In addition, the third reinforcing portion 124 includes side surface reinforcing portions 126 to reinforce side surfaces of the protruding end 116′, and a fixing projection 127 to notify completion of connection of the plug connector 200.

The side surface reinforcing portions 126 may be formed by being bent from both sides of an outer end surface of the third reinforcing portion 124 inwardly, that is, toward the protruding end of the center protrusion portion 116 (−x direction). The side surface reinforcing portions 126 are coupled to both side surface of the protruding end 116′ of the receptacle housing 110, thereby reinforcing stiffness of the side surfaces of the protruding end 116′. In this case, a resin hole 128 is formed on the outer end surface of the third reinforcing portion 124 to allow a resin to easily flow in an over molding process.

The fixing projection 127 protrudes outward from a surface of the side surface reinforcing portion 126. The projection recess 227 in a recess shape may be formed on an inner surface of the plug metal bracket 220 to correspond to the fixing projection 127. When the plug connector 200 is connected to the receptacle connector 100, the fixing projection 127 presses an inner surface of the plug metal bracket 220 and is seated and received in the projection recess 227 of the plug metal bracket 220 when connection is completed (see FIG. 5).

As described above, the receptacle connector 100 of the present embodiment detects connection of the plug connector 200 at two positions of the elastic protrusion 125 and the fixing projection 127, and can enhance a feeling of clicking on the connection of the connector. In the description of the present embodiment, the fixing projection 127 is formed on the receptacle metal bracket 120, and the projection recess 227 is formed on the plug metal bracket 220. However, the projection recess may be formed on the receptacle metal bracket 120, and the fixing projection may be formed on the plug metal bracket 220.

Referring to FIG. 9, in the receptacle metal bracket 120 according to another embodiment, the side surface reinforcing portions 126 may be formed by being directly bent from both sides of an upper surface of the third reinforcing portion 124 downward (−z direction). In this case, an outside portion of the third reinforcing portion 124 is opened to allow an injection molding material to easily flow into a lower space of the third reinforcing portion 124 when double injection molding is performed.

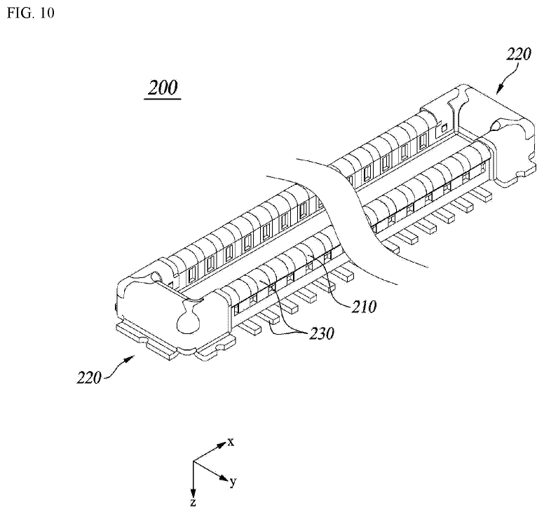

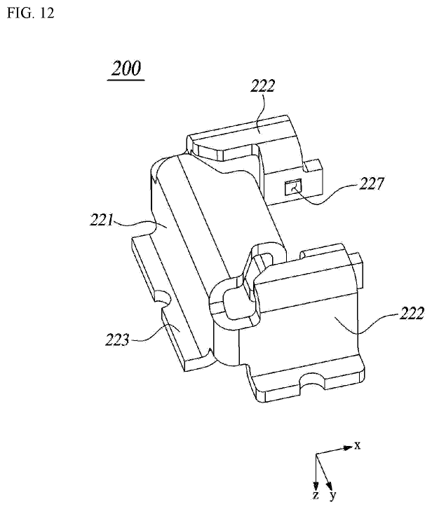

FIG. 10 is a bottom perspective view of a plug of the present embodiment, FIG. 11 is an exploded view showing the plug of FIG. 10, and FIG. 12 is a perspective view showing a plug metal bracket which is a main part of FIG. 10.

As shown in FIGS. 10 and 11, in the plug connector 200 of the present embodiment, the plug housing 210 forms a rectangular parallelepiped shape having a predetermined width and a predetermined length, and includes a second bottom portion 211, one pair of third sidewall portions 212 protruding along both side borders of the second bottom portion 211 in the longitudinal direction, and one pair of fourth sidewall portions 213 protruding along both side borders of the second bottom portion 211 in the width direction and connecting both ends of the third sidewall portions 212. The second bottom portion 211, the third sidewall portions 212, and the fourth sidewall portions 213 are integrally connected with one another by injection molding.

The third sidewall portions 212 and the fourth sidewall portions 213 are walls having a predetermined thickness, and face each other and are symmetric to each other on both sides of the second bottom portion 211 in the longitudinal direction and in the width direction, respectively, and are connected with one another. In addition, the fourth sidewall portion 213 includes a second main body portion 214 forming a wall in the width direction, and one pair of second extension portions 215 extending inward from both ends of the second main body portion 214 in the longitudinal direction to be connected to the third sidewall portions 212.

The one pair of third sidewall portions 212 and the one pair of fourth sidewall portions 213 are connected with one another, thereby forming a track or rectangular shape corresponding to the first connection recess portion 117 of the receptacle housing 110, and form a second connection recess portion 216 therein to receive the center protrusion portion 116 of the receptacle housing 110. Accordingly, when the receptacle connector 100 and the plug connector 200 are coupled to each other, the third sidewall portions 212 and the fourth sidewall portions 213 of the plug housing 210 are inserted into the first connection recess portion 117 of the receptacle housing 110, and simultaneously, the center protrusion portion 116 of the receptacle housing 110 is inserted into the second connection recess portion 216 of the plug housing 210.

In addition, the plug terminal hole 218 concavely recessed or penetrating is formed on the third sidewall portion 212. The plurality of plug terminal holes 218 may be formed at predetermined intervals along the longitudinal direction, and each of the plug terminal holes 218 receives the plug terminal 230.

The plug metal bracket 220 may be coupled to both ends of the plug housing 210, that is, to the fourth sidewall portions 213, to reinforce the stiffness of the plug housing, and to fix the plug housing 210 to the second board 20.

Referring to FIG. 12, the plug metal bracket 220 includes a fourth reinforcing portion 221 coupled to the second main body portion 214 of the fourth sidewall portion 213, and one pair of fifth reinforcing portions 222 connected to the outside at both ends of the fourth reinforcing portion 221 to be coupled to the second extension portions 215 of the fourth sidewall portion 213. The fourth reinforcing portion 221 and the fifth reinforcing portions 222 may be bent in an inverted U shape, and may be coupled while surrounding surfaces of the second main body portion 214 and the second extension portions 215, and may be bent from outer surfaces of the second main body portion 214 and the second extension portions 215 along inner surfaces or may be bent from the inner surfaces along the outer surfaces.

Each of the fourth reinforcing portion 221 and the fifth reinforcing portions 222 includes a second soldering portion 223 bent from a lower end thereof outward or inward in the horizontal direction to be soldered to the second board 20. The second soldering portion 223 may be formed on all of inside and outside lower ends of the fourth reinforcing portion 221 and the fifth reinforcing portions 222.

In addition, the fifth reinforcing portion 222 further includes the projection recess 227 to notify completion of connection of the receptacle connector 100. The projection recess 227 is formed on the fifth reinforcing portion 222 that contacts an inner surface of the second extension portion 215, as a position corresponding to the fixing projection 127 of the receptacle metal bracket 120. The projection recess 227 receives the fixing projection 127 when connection of the receptacle connector 100 and the plug connector 200 is completed, thereby allowing the operator to easily detect the completion of the connection of the connector.

Although exemplary embodiments of the present disclosure have been illustrated and described as above, various changes and other embodiments can be implemented by those skilled in the art. It should be noted that such changes and other embodiments are considered and included in the appended claims, and do not depart from the genuine purpose and the scope of the present disclosure.

1. A receptacle connector comprising:
a receptacle housing comprising: first sidewall portions protruding along both side borders of a bottom portion that face each other; second sidewall portions protruding along the other side borders of the bottom portion that face each other to be connected with the first sidewall portions;
a center protrusion portion protruding from a center of the bottom portion; and a connection recess portion formed between the first sidewall portions and the second sidewall portions, and the center protrusion portion;
receptacle metal brackets soldered to a board and coupled to the second sidewall portions and protruding ends of the center protrusion portion; and
receptacle terminals received in receptacle terminal holes formed on the receptacle housing,
wherein the receptacle metal bracket comprises: a first connection sensing member configured to provide a feeling of clicking of connection by elastically pressing the plug metal bracket; and a second connection sensing member configured to provide a feeling of clicking of connection by releasing pressure on the plug metal bracket.

2. The receptacle connector of claim 1,
wherein the second sidewall portion comprises a main body portion in a width direction, and extension portions extending from both ends of the main body portion in a longitudinal direction to be connected to the first sidewall portions, and
wherein the receptacle metal bracket comprises: a connection portion; a first reinforcing portion extending upward from an end of one side of the connection portion to be coupled to the main body portion; one pair of second reinforcing portions extending upward from ends of both sides of the connection portion to be coupled to the extension portions; and a third reinforcing portion extending upward from an end of the other side of the connection portion facing the first reinforcing portion to be coupled to the protruding end.

3. The receptacle connector of claim 2,
wherein the first connection sensing member comprises: a fixing piece formed by cutting a part of the second reinforcing portion and connected to the connection portion; and an elastic piece protruding inward from an end of the fixing piece to elastically press an outer surface of the plug metal bracket.

4. The receptacle connector of claim 2,
wherein the third reinforcing portion comprises side surface reinforcing portions coupled to both side surfaces of the protruding end.

5. The receptacle connector of claim 4,
wherein the second connection sensing member is a fixing projection or a projection recess which is formed on an outer surface of the side surface reinforcing portion to be engaged with a connection sensing member formed on a surface of the plug metal bracket.

6. The receptacle connector of claim 4,
wherein the side surface reinforcing portions are formed by being bent from both sides of an outer end surface of the third reinforcing portion toward the protruding end.

7. The receptacle connector of claim 6,
wherein the third reinforcing portion has a resin hole formed on the outer end surface thereof to allow a resin to flow therethrough.

8. The receptacle connector of claim 4,
wherein the side surface reinforcing portions are formed by being bent from both sides of an upper surface of the third reinforcing portion downward.

9. A connector assembly, comprising:
the receptacle of claim 1; and
a plug which is configured to mate with the receptacle.
